(19) United States
(12) Patent Application Publication
(10) Pub. No.: US 2018/0032843 A1
(43) Pub. Date: Feb. 1, 2018

(54) IDENTIFYING CLASSES ASSOCIATED WITH DATA

(71) Applicant: Hewlett Packard Enterprise Development LP, Houston, TX (US)

(72) Inventors: Florian Raudies, Palo Alto, CA (US); Raymond Roccaforte, Palo Alto, CA (US)

(21) Appl. No.: 15/223,706

(22) Filed: Jul. 29, 2016

(51) Int. Cl. G06K 9/62; G06N 3/08; G06F 17/14

(52) U.S. Cl. CPC G06K 9/6269; G06F 17/14; G06N 3/08; G06K 9/6202

(57) ABSTRACT

An example device in accordance with an aspect of the present disclosure includes an initialization engine and a system usage engine. The initialization engine is to generate a collection of signatures representing canonical data and structure in canonical data. The system usage engine is to create a generated signature of a transformed datum, compare the generated signature to the collection of signatures, and identify a class of the generated signature based on the comparison.

### BACKGROUND

Data can be processed to recognize and/or classify a given object. It is desirable to recognize the object regardless of the viewpoint. This is referred to as invariance to viewpoint transformations.

### BRIEF DESCRIPTION OF THE DRAWINGS/FIGURES

FIG. 1 is a block diagram of a system including an initialization engine and a system usage engine according to an example.

FIG. 2 is a block diagram of a system including an initialization engine and a system usage engine according to an example.

FIG. 3 is a block diagram of a system including a multiplexed signal, a collection of templates, and a collection of signatures according to an example.

FIG. 4 is a diagram of a plurality of images and their corresponding Fourier spectra according to an example.

FIG. 5 is a block diagram of a system including an initialization engine and a system usage engine according to an example.

FIG. 6 is a flow chart based on identifying a class according to an example.

FIG. 7 is a block diagram of a system including initialization instructions and system usage instructions according to an example.

### DETAILED DESCRIPTION

Objects in images can have different structures, such as different tiling. Vast databases of training data can be used to present an exhaustive supply of possible cases of invariances and structure during training of a network. However, processing the data (e.g., 1.2 million images for a given instance) and adjusting the parameters of a deep convolutional network can take days of computing time.

To address such issues, examples described herein may provide a classification system that uses a signature as a viewpoint invariant representation of data. In addition, examples can use multiple signatures, one per structure in the data. Such approaches provide benefits compared to using a single signature and/or using approaches that are ignorant of structure in data. Furthermore, instead of needing millions of images and days of training, example implementations described herein can construct several signatures, one per structure, each being invariant to viewpoint. This reduces the amount of training data to one per class, which is minimal. Accordingly, there is no need to devote resources to labeling, e.g., millions of images or other data by hand. Because example implementations need only one data per class, and the processing itself for that one data per class is computationally cheap, there is no need for long training times, especially compared to deep convolutional neural networks.

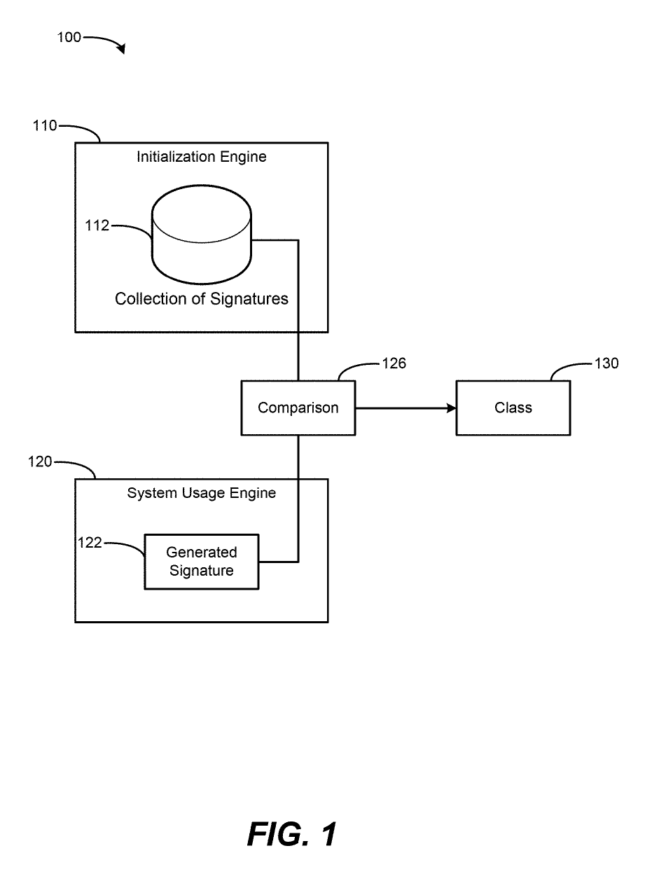

FIG. 1 is a block diagram of a system 100 including an initialization engine 110 and a system usage engine 120 according to an example. The initialization engine 110 is associated with a collection of signatures 112, and the system usage engine 120 is associated with a generated signature 122. A comparison 126 results in a class 130.

More specifically, the initialization engine 110 is to generate a collection of signatures 112 representing canonical data. A given signature is viewpoint invariant. The system usage engine 120 is to create a generated signature 122 of a transformed datum. The system usage engine 120 can generate the signature 122 based on data provided to the system usage engine 120. The system usage engine 120 is to compare (based on comparison 126) the generated signature 122 to the collection of signatures 110, and identify a class 130 of the generated signature based on the comparison 126.

As described herein, the term “engine” may include electronic circuitry for implementing functionality consistent with disclosed examples. For example, engines 110 and 120 represent combinations of hardware devices (e.g., processor and/or memory) and programming to implement the functionality consistent with disclosed implementations. In examples, the programming for the engines may be processor-executable instructions stored on a non-transitory machine-readable storage media, and the hardware for the engines may include a processing resource to execute those instructions. An example system (e.g., a computing device), such as system 100, may include and/or receive the tangible non-transitory computer-readable media storing the set of computer-readable instructions.

In general, classification tasks are common. For instance, objects depicted in images can be classified as, e.g., dangerous, harmful, critical, neutral, etc. Objects depicted in images also can be recognized as, e.g., dogs, cats, flowers, trees, houses, etc. Patterns of mouse movements and clicks can be classified as to whether an internet user clicks on an advertisement or not. A Uniform Resource Identifier (URL) can be classified as malicious or harmless. These example data contain certain invariances, e.g., such as their viewpoint, or deformations of the mouse position of clicking patterns, or permutations in the characters of a URL, and so on. In addition, the data may contain structure. For instance, in one image there may be larger patches of almost homogenous colors, whereas in another image the patches are much smaller. In another instance, an internet user may make small strokes of pointer movements probably limited by the screen of his/her smart device, while another user may make long strokes of pointer movements during browsing. Such example structures in the data can vary.

Prior approaches might use a computationally expensive training phase, often taking all available data, especially multiple data per class. Example implementations described herein can instead use the minimum distance classifier, which does not need training. Accordingly, an initialization phase (that can be compared to the training phase of classifiers or deep convolutional networks more specifically) needs only one datum per class. This number of one datum per class is minimal. The storage of templates and computation and storage of signatures is efficient.

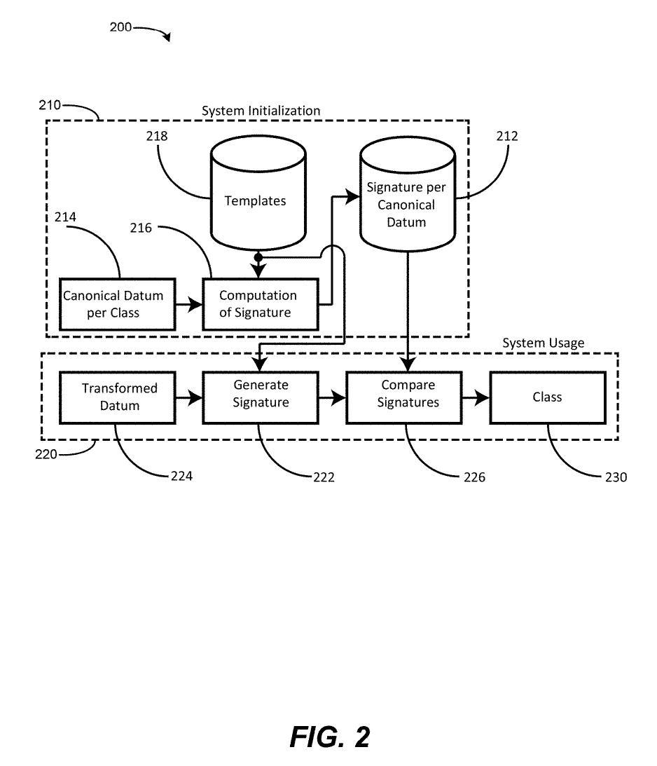

FIG. 2 is a block diagram of a system 200 including an initialization engine 210 and a system usage engine 220 according to an example. The initialization engine 210 is associated with canonical datum per class 214, computation of signature 216, templates 218, and signature per canonical datum 212. The system usage engine 220 is associated with transformed datum 224, generate signature 222, compare signatures 226, and class 230.

The example system 200 can be performed in two phases, system initialization as provided by the initialization engine 210, and system usage as provided by the system usage engine 220. During system initialization, canonical data, one datum per class, are supplied by the user as indicated by block 214. Templates are chosen according to the data structure, and not at random as in prior solutions, as indicated by block 218. The canonical datum 214 is then used together with the templates 218 to compute one signature per canonical datum and class, as indicated by block 216. These signatures, one per canonical datum and class, are then stored together with the class information, e.g., in a database indicated by block 212.

During system usage as indicated by the system usage engine 220, the user is to supply a transformed datum as indicated in block 224. This transformed datum 224 is used, together with the templates 218, to generate another signature, as indicated by block 222. This generated signature 222 is then compared to the signatures 212 in the database, as indicated by block 226. The comparison between signatures can be performed, e.g., using a distance norm (such as a Euclidian approach) in the n-dimensional space. The system usage engine 220 can then return the class 230, which corresponds to the smallest distance as a result of the comparison 226.

With reference to the templates 218, example systems build upon the construction of signatures 216, 212, which are invariant to compact group transformations, and extensions thereof toward non-compact group transformations and non-groups. These signatures are computed through the projection of the data onto random vectors, referred to herein as templates, under the transform.

With reference to the canonical datum per class 214, the canonical datum per class can be given by a user to the system 200. For instance, data 214 can include images depicting digits in several rotations within 360 degrees. A canonical datum of each image depicting a digit could show the digit at zero degrees rotation. Another example is the detection of labels on packages that pass by a camera at any orientation and shifted positions. In this example, the canonical datum could be a top-down view of the package with the label centered and at zero degrees rotation. This concept of canonical datum is not restricted to image data. For instance, in audio recordings speakers' starting times may vary slightly in time within the segment of interest. Then, the canonical representation could be segmentation into snippets of the audio signal that follows the exact timeline of a storyboard. Another example of canonical datum comes from mouse movements and clicking patterns of users browsing the internet. In such an example, a canonical datum could be the zero degrees orientation of clicking patterns with respect to the image screen, e.g., such that canonical clicking patterns are treated as “upright.”

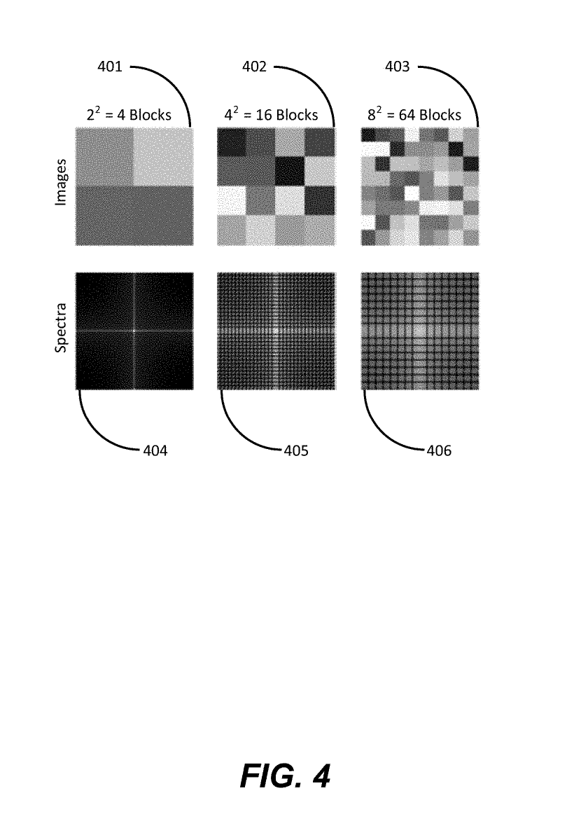

With reference to the templates 218, example implementations described herein can use templates that target multiple structures, unlike prior approaches that chose templates at random or following a Gabor filter construction (which would be problematic for data sets with data that contain various structures). For instance, if the data used by system 200 has M structures, the system 200 can generate templates for these M structures. This construction assumes that all canonical data is known during the initialization phase of the system 200. This allows for the analysis of the structure in canonical data 214. In applications such as classification based on image data, audio data, or clicking patterns, a Fourier transform can be used to detect structure in the data using Fourier spectra (see example Fourier spectra 404-406 shown in FIG. 4). Other techniques can be used to identify structure, such as using correlation techniques. An example for images: Structure can generally be described as detecting the shape of a scene, e.g., whether it depicts an outdoor or indoor scene.

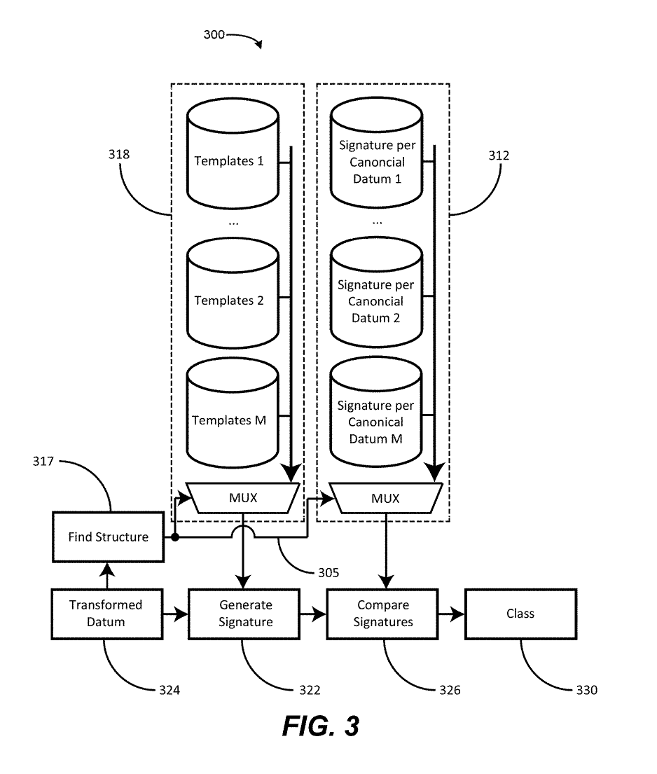

FIG. 3 is a block diagram of a system 300 including a multiplexed signal 305, a collection of templates 318, and a collection of signatures 312 according to an example. System 300 also includes a block corresponding to transformed datum 324, a block corresponding to find structure 317, a block corresponding to generate signature 322, a block corresponding to compare signatures 326, and a block corresponding to class 330.

A notable concept of example systems described herein is that of proposing separate signatures 312 for separate image structures 317. System 300 can include stored templates 318 and stored signatures 312. One signature 312 is stored per structure per class. Multiple templates 318 are stored per structure. Thus, each stored template 318 or signature 312 contains information about its structure and class. As set forth above regarding FIG. 2, after initialization and during system usage, the user is to supply a transformed datum 324. Then, the system can use various techniques to find the structure 317 in that datum, e.g., by using a Fourier transform. The system 300 can then provide a multiplexed signal 305 to the template storage 318 and to the signature storage 312, to select the templates and signatures for the detected structure 317. The creation of the generated signature 322 for the provided, transformed input data is performed for the selected templates of matching structure. This generated signature 322 is passed on to the comparison of signatures 326. At block 326, the system 300 compares the generated signature 322 against the stored signatures 312 for the same structure. Finally, the class 330, corresponding to, e.g., a minimum distance comparison between the stored signature and current signature, is provided as a result (which can be returned to the user).

As for the generation of a signature (e.g., block 322), the system 300 can perform various computations. A descriptive explanation for an example computation of the signature is provided, followed by an example using formal mathematical expressions. Assume a datum IεR^{S} being a canonical datum for one class. The components of the signature are computed by projecting this datum onto the transformed templates gt^{k}. These templates have been transformed by using the group operator gεG of the group G. After the projection, the resulting value is passed through the nonlinearity function ηⱼ. To compute the j^{th} component for the k^{th} template, the system can sum over all elements the in the group gεG. The output values of the nonlinearity are normalized by the number of elements |G| in the group.

Formally, assume datum I is given, then its signature Σ(I) is:

Σ(I)=(μ¹(I), . . . ,μ^{K}(I))=(μ₁¹(I), . . . ,μ_{L}¹(I), . . . , . . . ,μ₁^{K}(I), . . . ,μ_{L}^{K}(I)), (1)

where each μ^{K}(I)εR^{KL} is a histogram of L bins corresponding to a one-dimensional projection of the image I onto a transformed template gt^{k}.

More specifically, the j^{th} component of the histogram μ^{k}(I) corresponding to template t^{k} in (1) is computed by:

$${μ}_{j}^{k} ( I ) = \frac{1}{\vert G \vert} {\sum }_{g ∈ G} {η}_{j} ( 〈 I , {gt}^{k} 〉 ) , \qquad ( 2 )$$

where ηⱼ can be chosen to represent various non-linearities and [symbol] . , . [symbol] denotes the inner product or projection. In practice, ηⱼ can be taken to be the statistical moment

ηⱼ(x)=x^{j}, for j=1 . . . L (3)

or as the binning function

$${η}_{j} ( x ) = \{ \begin{matrix}1 & if a + \frac{j}{L} ( b - a ) < x x < a + \frac{j + 1}{L} ( b - a ) \\ 0 & else\end{matrix} \qquad ( 4 )$$

with L being the number of bins in the interval [a, b].

All signatures, one per canonical datum and class, are stored with their class information. In use-cases the storage per structure does not need an efficient access method, because all signatures are used by the algorithm. An efficient access of all stored signatures for one class can be achieved by using a linear index for structures.

With reference to the concept of transformed datum (block 324), a transformed datum is supplied by the user. For instance, in our example of images depicting digits, such transformed data could be a rotated version of the digit.

With reference to comparing signatures (block 326), to compare two signatures Σ₁ and Σ₂, example implementations can use the Euclidean distance d(Σ₁, Σ₂)=∥Σ₁−Σ₂∥, with the assumption that all stored signatures for a structure l are indexed by s. Then, the signature storage 312 contains the signatures Σₗₛ. The index l is provided by the illustrated multiplexer(s) (MUX). The index s is associated with a class for a given structure and is unknown for a user-supplied data I with the signature Σ. Examples can use the minimum distance classifier:

$$\hat{s} = arg {min}_{s} ‖ Σ - {Σ}_{is} ‖ \qquad ( 5 )$$

to compute the most likely class ŝ for the user supplied data I with the computed signature Σ.

With reference to class (block 330), this is the class ŝ the system has found to be the most likely class for the user-provided, transformed datum I.

As for storage complexity, the number of templates K increases only logarithmically with the number of classes N. Example implementations can use the proportionality K˜log(N). Thus, storage needed for signatures and templates is small. To store N signatures, one per class, O(N K L) or O(N log(N) L) floating point values are needed, where K is the number of templates and L the number of bins used in Eq. (3) or (4). To store the templates for these signatures, O(S K) or O(S log(N)) floating point values are needed for S dimensions in the datum, with the assumption that the group transform gεG is re-computed for each incoming computation of signatures, rather than storing templates for all group transforms.

As for computational complexity, the group G may have an infinite amount of elements, e.g., all rotations in 360 degrees in a planar image. However, example systems, when using the histogram-based signature from Eq. (4), can cover all these possible rotations in 360 degrees, through as little as eight rotations for computing the templates, while achieving a classification accuracy above 90%. This smaller subset of all group elements can be called Gₐ. Note that often |Gₐ|<<|G|. This subset Gₐ replaces the set G in Eq. (2), which reduces the computational complexity. The computation of signatures takes O(S log(N) L|Gₐ|) floating point operations. The computation of the minimum distance takes O(S log(N) L) floating point operations. Typical values for L are ≈10. Typical values for S range from 128² to 256², which corresponds to the image sizes of 128×128 pixels to 256×256 pixels. Typical values for the number of classes N range from 10 to 1000. For instance, the so-called ImageNet challenge has N=1000 classes, and the so-called MNIST image digit set has N=10 classes.

Prior solutions choose templates at random, or following a Gabor filter construction. However, such approaches do not take into account the structure in data, and are therefore agnostic to the structure within the data, using a single signature for all structures. In contrast, examples described herein can use separate signatures for separate structures. In one example, a system can use 256 images of size 32×32 pixels, 32 templates for 4-by-4 blocks and 16-by-16 blocks, respectively, or 64 templates for a single signature, 16 rotations equally spaced in 360 degrees for templates and 16 random rotations for test images, 11 bins for the histogram-based signature, and 2 moments for the moment-based signature. A classification accuracy of 79.91% was achieved for this example, much higher than prior solutions based on a single structure for all structures. The example system using two histogram-based signatures achieved a classification accuracy of 90.03%, illustrating the improvement in classification accuracy (output performance of the system) when using multiple signatures for multiple structures.

FIG. 4 is a diagram of a plurality of images 401-403 and their corresponding Fourier spectra 404-406 according to an example. The illustrated images 401-403 demonstrate a checkerboard texture of varying block size that can be used to demonstrate structure in images, and detection of the structure, through Fourier transform. The images 401-403 each have a size of 128×128 pixels. A block in the image contains several pixels, such as (128/2)²=4096 pixels for 4 blocks in image 401, (128/4)²=1024 pixels for 16 blocks in image 402, and (128/8)²=256 pixels for 64 blocks in image 403. The respective spectra 404-406 of these images have clearly different characteristics, as for 4 blocks in spectra 404, for 16 blocks in spectra 405, and for 64 blocks in spectra 406.

Even though there can be an infinite number of structures in data, the example implementations described herein can approximate the infinite through a finite set of structures. For instance, a system can approximate several neighboring structures through a single signature. For structures far apart from each other, multiple signatures can be used.

The mechanism of using Fourier spectra also can be used to decide upon the structure in transformed data, with the assumption that the transform does not change the sensitivity of the structure detector. For instance, for rotational transforms of two-dimensional (2D) image data, the spectrum is rotated as well. However, in most cases, only the outline or shape of the spectrum is used to decide upon the structure, and not its orientation. Such a detector that is based on the shape of the Fourier spectrum is invariant under the rotational transform of 2D images.

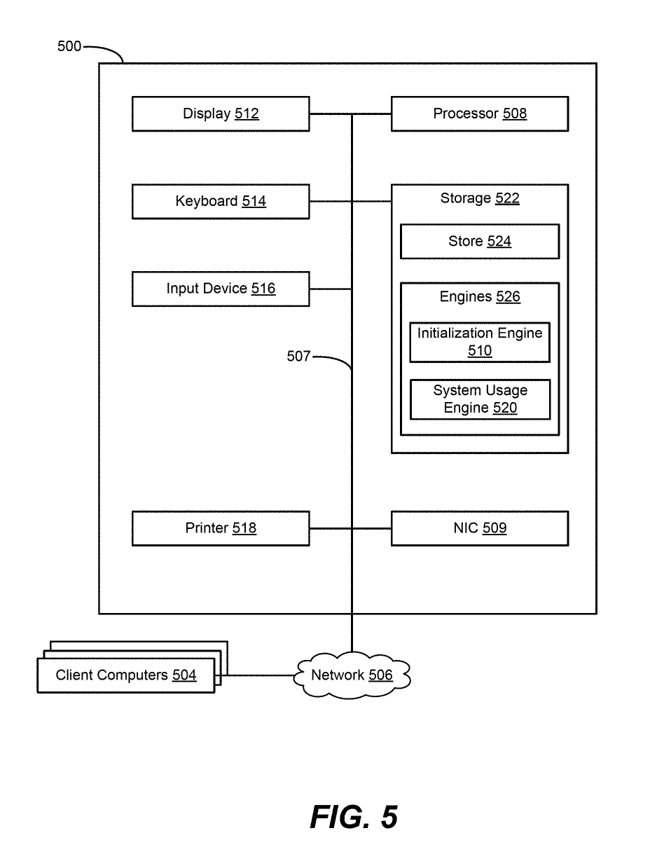

FIG. 5 is a block diagram of a system 500 including an initialization engine 510 and a system usage engine 520 according to an example. The system 500 also includes processor 508, display 512, keyboard 514, input device 516, storage 522, printer 518, network interface card (NIC) 509. The system 500 is coupled to network 506, which is coupled to client computers 504.

As used herein, a computing system/device 500 may refer to systems such as a server, a personal computer, a tablet computer, and the like. The computing system 500 may include one or more processors 508, which may be connected through a bus 507 to a display 512, a keyboard 514, one or more input devices 516, and an output device, such as a printer 518. The input devices 516 may include devices such as a mouse or touch screen. The processors 508 may include a single core, multiples cores, or a cluster of cores in a cloud computing architecture. In some examples, the processors 508 may include a graphics processing unit (GPU). The computing system 500 may also be connected through the bus 507 to a network interface card (NIC) 509. The NIC 509 may connect the computing system 500 to the network 506.

The network 506 may be a local area network (LAN), a wide area network (WAN), or another network configuration. The network 506 may include routers, switches, modems, or any other kind of interface device used for interconnection. The network 506 may connect to several client computers 504. Through the network 506, several client computers 504 may connect to the computing system 500. Further, the computing system 500 may access resources across network 506. The client computers 504 may be similarly structured as the computing system 500.

The computing system 500 may have other units operatively coupled to the processor 508 through the bus 507. These units may include non-transitory, tangible, machine-readable storage media, such as storage 522. The storage 522 may include any combinations of hard drives, read-only memory (ROM), random access memory (RAM), RAM drives, flash drives, optical drives, cache memory, and the like. The storage 522 may include a store 524, which can include information captured or generated in accordance with an embodiment of the present techniques. Although the store 524 is shown to reside on computing system 500, the store 524 may reside in a location accessible via the network 506, such as on a client computer 504.

The storage 522 may include a plurality of engines 526, including initialization engine 510 and system usage engine 520. The engines 526 may include combinations of hardware and/or instructions to execute the methods described herein.

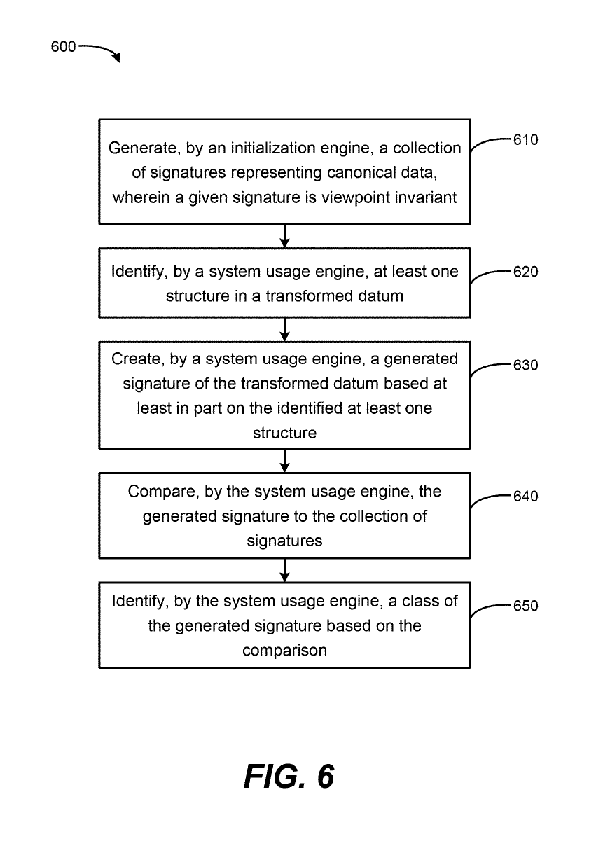

Referring to FIG. 6, a flow diagram is illustrated in accordance with various examples of the present disclosure. The flow diagram represents processes that may be utilized in conjunction with various systems and devices as discussed with reference to the preceding figures. While illustrated in a particular order, the disclosure is not intended to be so limited. Rather, it is expressly contemplated that various processes may occur in different orders and/or simultaneously with other processes than those illustrated.

FIG. 6 is a flow chart 600 based on identifying a class according to an example. In block 610, an initialization engine is to generate a collection of signatures representing canonical data, wherein a given signature is viewpoint invariant. For example, a canonical datum can be used together with templates to compute one signature per canonical datum and class. In block 620, a system usage engine is to identify at least one structure in a transformed datum. For example, a user can supply a transformed datum, and a Fourier transform can be used to identify at least one structure of the datum. In block 630, a system usage engine is to create a generated signature of the transformed datum based at least in part on the identified at least one structure. For example, the transformed datum is used together with templates to create the generated signature. In block 640, the system usage engine is to compare the generated signature to the collection of signatures. For example, a distance norm can be applied in n-dimensional space. In block 650, the system usage engine is to identify a class of the generated signature based on the comparison. For example, based on the comparison, the system can identify the class as that comparison with the smallest distance.

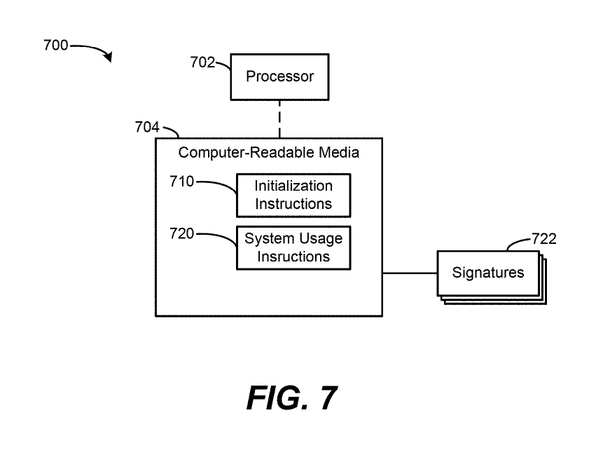

FIG. 7 is a block diagram of a system 700 including initialization instructions 710 and system usage instructions 720 according to an example. Processor 702 is coupled to tangible non-transitory computer-readable media 704, which is associated with signatures 722.

Examples provided herein may be implemented in hardware, software, or a combination of both. Example systems can include the processor 702 and memory resources for executing instructions 710, 210 stored in the tangible non-transitory medium 704 (e.g., volatile memory, non-volatile memory, and/or computer readable media). Non-transitory computer-readable medium 704 can be tangible and have computer-readable instructions 710, 720 stored thereon that are executable by the processor 702 to implement examples according to the present disclosure.

An example system (e.g., including a controller and/or processor of a computing device) can include and/or receive the tangible non-transitory computer-readable medium 704 storing the set of computer-readable instructions 710, 720 (e.g., as software, firmware, etc.) to execute the methods described above and below in the claims. For example, a system can execute instructions to direct an initialization engine to generate a collection of signatures, and to direct a system usage engine to identify a class, wherein the engine(s) include any combination of hardware and/or software to execute the instructions described herein. Thus, operations performed when instructions 710 and 720 are executed by processor 702 may correspond to the functionality of engines 110 and 120 of FIG. 1. As used herein, the processor 702 can include one or a plurality of processors such as in a parallel processing system. The memory can include memory addressable by the processor 702 for execution of computer readable instructions. The computer readable medium 704 can include volatile and/or non-volatile memory such as a random access memory (“RAM”), magnetic memory such as a hard disk, floppy disk, and/or tape memory, a solid state drive (“SSD”), flash memory, phase change memory, and so on.

What is claimed is:

1. A computing system comprising:
an initialization engine to generate a collection of signatures representing canonical data, wherein a given signature is viewpoint invariant; and
a system usage engine to create a generated signature of a transformed datum, compare the generated signature to the collection of signatures, and identify a class of the generated signature based on the comparison.

2. The computing system of claim 1, wherein the collection of signatures includes at least one signature per structure of a given datum.

3. The computing system of claim 2, wherein canonical data represents a plurality of data such that no more than one canonical datum, represented by a corresponding at least one generated signature, is needed to represent a given class.

4. The computing system of claim 1, wherein the initialization engine is to generate a given signature by projecting a given datum onto a template.

5. The computing system of claim 4, wherein the template is a random vector.

6. The computing system of claim 4, wherein the template corresponding to a datum is chosen according to a structure in the training data provided at initialization.

7. The computing system of claim 1, wherein the initialization engine is to detect a structure of a given datum by applying a Fourier transform to generate Fourier spectra for the given datum.

8. The computing system of claim 1, wherein the initialization engine is to identify structure in a transformed data, based on identifying Fourier spectra that has been similarly transformed.

9. The computing system of claim 1, wherein the initialization engine is to approximate a plurality of neighboring structures in a given datum via a single signature for that datum.

10. The computing system of claim 1, wherein the system usage engine is to create the generated signature based on at least one datum per class and at least one template and its transformations in total.

11. The computing system of claim 1, wherein the system usage engine is to compare the generated signature to the collection of signatures using a distance norm in n-dimensional space.

12. A method, comprising:
generating, by an initialization engine, a collection of signatures representing canonical data, wherein a given signature is viewpoint invariant;
identifying, by a system usage engine, at least one structure in a transformed datum;
creating, by a system usage engine, a generated signature of the transformed datum based at least in part on the identified at least one structure;
comparing, by the system usage engine, the generated signature to the collection of signatures; and
identifying, by the system usage engine, a class of the generated signature based on the comparison.

13. The method of claim 12, wherein the at least one structure in the transformed datum is identified based on a Fourier transform.

14. A non-transitory machine-readable storage medium encoded with instructions executable by a computing system that, when executed, cause the computing system to:
generate, by an initialization engine, a collection of signatures representing canonical data, wherein a given signature is viewpoint invariant;
identify, by a system usage engine, at least one structure in a transformed datum;
create, by a system usage engine, a generated signature of the transformed datum based at least in part on the identified at least one structure;
compare, by the system usage engine, the generated signature to the collection of signatures for the identified at least one structure; and
identify, by the system usage engine, a class of the generated signature based on the comparison.

15. The storage medium of claim 14, wherein the class is identified based on a minimum distance comparison.
